(19) United States
(12) Patent Application Publication
(10) Pub. No.: US 2016/0166469 A1
(43) Pub. Date: Jun. 16, 2016

(54) SAMPLING DEVICE

(71) Applicant: PREMIER BIOTECH, INC., Excelsior, MN (US)

(72) Inventors: Kevin S. FULLER, Lake Elmo, MN (US); Wayde J. ALTENDORF, Hickson, ND (US)

(21) Appl. No.: 14/886,954

(22) Filed: Oct. 19, 2015

Related U.S. Application Data
(60) Provisional application No. 62/065,524, filed on Oct. 17, 2014.

(51) Int. Cl. A61J 1/14; B29C 65/00; B29C 45/00; A61J 1/18; B01L 3/00

(52) U.S. Cl. CPC A61J 1/1418; A61J 1/18; B01L 3/508; B29C 45/006; B29C 66/5326; B01L 2300/042; B01L 2300/0609; B01L 2300/0832; B01L 2300/0851; B01L 2300/0858; B01L 2200/12; B29L 2031/712

(57) ABSTRACT

A specimen receiving device comprising a container portion having a bottom wall, a forward facing wall, a rearward facing wall, two side walls, defining an open interior and an upper peripheral portion defining an open top, wherein the container has a slot defined at an inside wall surface of the forward facing surface. The device further includes an assay strip panel sized to be received in the slot at the inside wall surface, the assay strip panel having a forward facing surface with a plurality of vertical slots, a top edge portion and a bottom portion that seats on the bottom wall; and a top portion sized for closing the open top and connecting with the upper lip, the top portion having a threaded neck portion with a circular opening for receiving a specimen and a lower opening defined by a peripheral portion sized to the upper peripheral portion; wherein the top portion has a spanning portion that, when the top portion is assembled with the container portion, traverses the open interior of the container portion and covers the top edge portion of the assay strip panel.

### CROSS-REFERENCE TO RELATED APPLICATIONS

The present application claims the benefit of U.S. Provisional Patent Application No. 62/065,524, filed Oct. 17, 2014, which is hereby incorporated by reference herein in its entirety.

### FIELD OF THE DISCLOSURE

This invention relates to a fluid collection and testing container for testing urine specimens. More particularly, the present invention relates to a self-contained fluid collection and testing container that is designed for the collection of urine and includes an internal assay strip panel that holds assay strips having diagnostic media for testing the urine specimen and a transparent viewing panel, through which the assay strips can be viewed.

### BACKGROUND OF THE DISCLOSURE

The testing of urine specimen has been performed by collecting a urine sample and placing one or more assaying strips into the urine sample to perform the test. This can be performed in a physician's office, police station, employment office, company or nearly any location. It would be advantageous to have a self-contained container for collection and testing to perform this function that is easy to use and to read, sealable and that protects the testing media.

### SUMMARY OF THE DISCLOSURE

The present invention relates generally to a specimen receiving device. In some embodiments, the device can comprise a container portion having a bottom wall, a forward facing wall, a rearward facing wall, two side walls, defining an open interior and an upper peripheral portion defining an open top. The container can a have a slot defined at an inside wall surface of the forward facing surface. The device further can comprise an assay strip panel sized to be received in the slot at the inside wall surface, the assay strip panel having a forward facing surface with a plurality of vertical slots, a top edge portion and a bottom portion that seats on the bottom wall. The device further comprises a top portion sized for closing the open top and connecting with the upper lip, the top portion having a threaded neck portion with a circular opening for receiving a specimen and a lower opening defined by a peripheral portion sized to the upper peripheral portion; wherein the top portion has a spanning portion that, when the top portion is assembled with the container portion, traverses the open interior of the container portion and covers the top edge portion of the assay strip panel.

In some embodiments, the spanning portion has assay strip panel engaging portions that secure the assay strip panel against the forward facing wall of the container portion.

In some embodiments, the assay strip panel has a pair of feet extending downward for engaging the bottom wall and the assay strip panel is elevated off of the bottom wall by the feet.

The assay panel can comprises a plurality of test strips with each test strip having and end tip extending toward the bottom wall.

In some embodiments, the container portion has a recess on the rearward facing wall and the rearward facing wall and the two side walls provide a tapering towards the bottom wall. In some embodiments, a specimen receiving device comprises a container portion having a bottom wall, a forward facing wall, a rearward facing wall, two side walls, defining an open interior and an upper peripheral portion defining an open top. The container can have a slot defined at an inside wall surface of the forward facing surface. The device further can comprise an assay strip panel received in the slot at the inside wall surface, the assay strip panel having a forward facing surface with a plurality of vertical slots, a top edge portion and a bottom portion that is seated at the bottom wall. The device further comprises a top portion connected to the upper lip, the top portion having a threaded neck portion with a circular opening for receiving a specimen and a lower opening defined by a peripheral portion sized to the upper peripheral portion. The device further comprises a shield positioned over the top edge portion of the assay strip panel and positioned below the circular opening for preventing the specimen from contacting the upper edge portion of the assay strip panel; and a cap for cooperating with the threaded neck portion to seal and close the specimen receiving device.

In some embodiments of the specimen receiving device, the shield is unitary with the top portion by way of molding. In some embodiments, the top portion is unitary with the container portion by way of welding.

In some embodiments, a method of assembling a specimen receiving device comprising inserting a panel of test strips adjacent a forward facing wall of a container portion, the forward facing wall being transparent or having a transparent window; and welding a top portion to the container portion, the top portion having a retainer that thereby captures and retains the panel against the forward facing wall and provides a shield over the panel to deflect collected specimen.

Some embodiments can include a method of manufacturing a specimen receiving device comprising injection molding a generally rectangular assay test strip panel that has a top edge and a bottom edge; and injection molding a container portion having a bottom wall with a foot print of a first area, and an open top defined by a peripheral lip, the open top with an area larger than the first area whereby the container portion tapers towards the bottom wall, the container portion having a slot for receiving the assay test strip panel; and injection molding a top portion that has a shield configured to cover the top edge of the panel.

In some embodiments, the method comprises placing the panel in the slot and welding the top portion to the container portion.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a front perspective view of a specimen receiving device according to embodiments of the invention.

FIG. 2 is a rear perspective view of a specimen receiving device according to embodiments of the invention.

FIG. 3 is a bottom view of a specimen receiving device according to embodiments of the invention.

FIG. 4 is an exploded view of a specimen receiving device according to embodiments of the invention.

FIG. 5 is a perspective view of a cap for a specimen receiving device according to embodiments of the invention.

FIG. 6 is a front bottom perspective view of a container for a specimen receiving device according to embodiments of the invention.

FIG. 7 is a rear bottom perspective view of a container for a specimen receiving device according to embodiments of the invention.

FIG. 8 is a top perspective view of a container for a specimen receiving device according to embodiments of the invention.

FIG. 9 is a top perspective view of a container for a specimen receiving device according to embodiments of the invention.

FIG. 10 is a top view of a container for a specimen receiving device according to embodiments of the invention.

FIG. 11 is a top perspective view of a container for a specimen receiving device according to embodiments of the invention.

FIG. 12 is a front perspective partial sectional view of a portion of a container for a specimen receiving device according to embodiments of the invention.

FIG. 13 is a front partial sectional view of a portion of a container for a specimen receiving device according to embodiments of the invention.

FIG. 14 is a bottom perspective view of a top portion for a specimen receiving device according to embodiments of the invention.

FIG. 15 is a bottom perspective view of a top portion for a specimen receiving device according to embodiments of the invention.

FIG. 16 is a bottom view of a top portion for a specimen receiving device according to embodiments of the invention.

FIG. 17 is a rear perspective view of a top portion for a specimen receiving device according to embodiments of the invention.

FIG. 18 is a front view of a top portion for a specimen receiving device according to embodiments of the invention.

FIG. 19 is a front perspective view of an assay strip panel for a specimen receiving device according to embodiments of the invention.

FIG. 20 is a rear perspective view of an assay strip panel for a specimen receiving device according to embodiments of the invention.

FIG. 21 is a front perspective view of an assay strip panel for a specimen receiving device according to embodiments of the invention.

FIG. 22 is a rear perspective view of an assay strip panel for a specimen receiving device according to embodiments of the invention.

FIG. 23 is a top perspective view of a specimen receiving device without a cap according to embodiments of the invention.

FIG. 24 is a side partial sectional view of a portion of a specimen receiving device according to embodiments of the invention.

FIG. 25 is a rear partial sectional view of a portion of a specimen receiving device according to embodiments of the invention.

FIGS. 26-27 are top partial sectional views of a lower portion of a specimen receiving device according to embodiments of the invention.

### DETAILED DESCRIPTION OF THE FIGURES

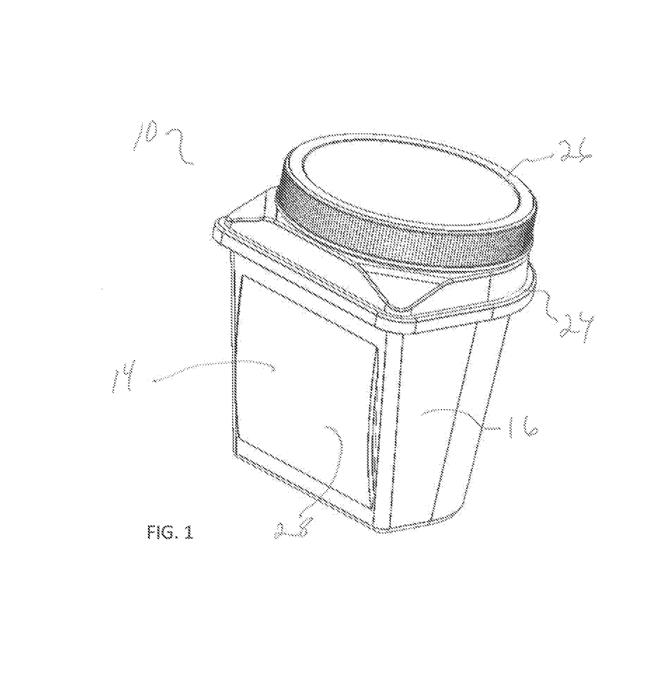

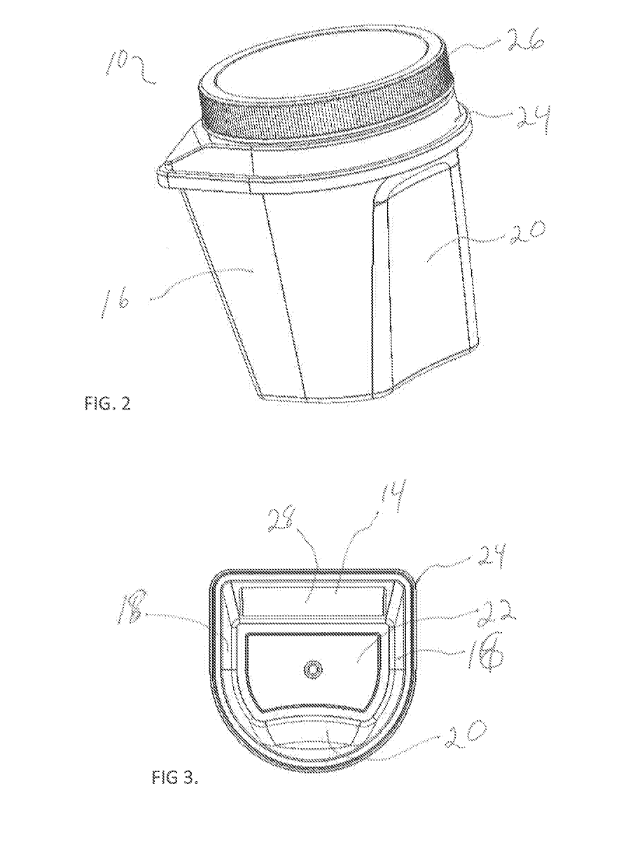

Referring to FIGS. 1-3, a specimen receiving device 10 is shown and comprises a container portion 12 having a forward facing wall 14, two side walls, a right side wall 16 and a left side wall 18, a rearward facing wall 20 and a bottom wall 22, a top portion 24 and a cap 26.

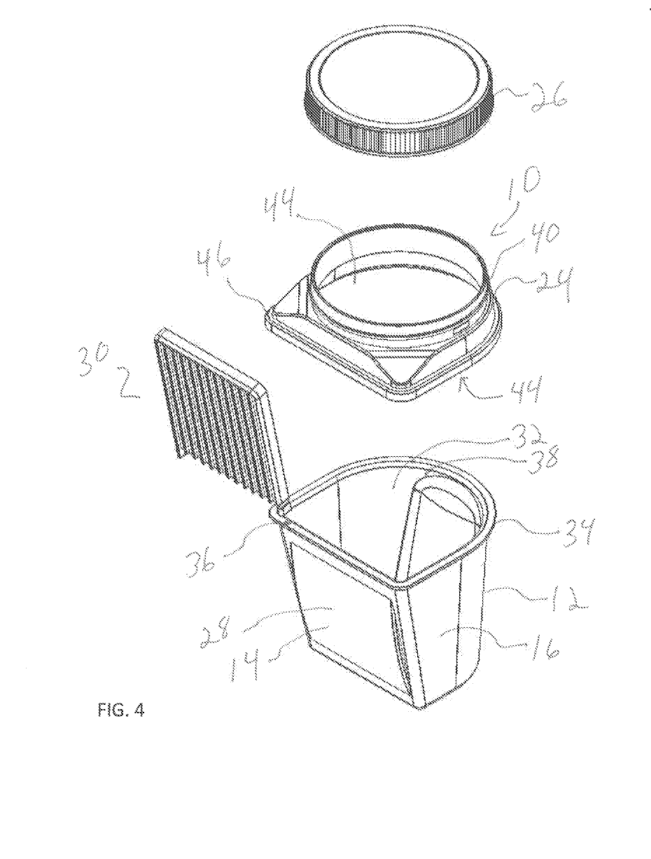

FIG. 4 shows an exploded view of the specimen receiving device 10. The specimen receiving device 10 further comprises an assay strip panel 30 which slidably fits in the container portion 12. The forward facing wall 14, two side walls 16, 18, and rearward facing wall 20 of the container portion 12 define an open interior 32 and an upper peripheral portion 34 having an upper lip 36 defining an open top 38. The top portion 24 is sized for closing the open top 38 and connecting with the upper lip 36.

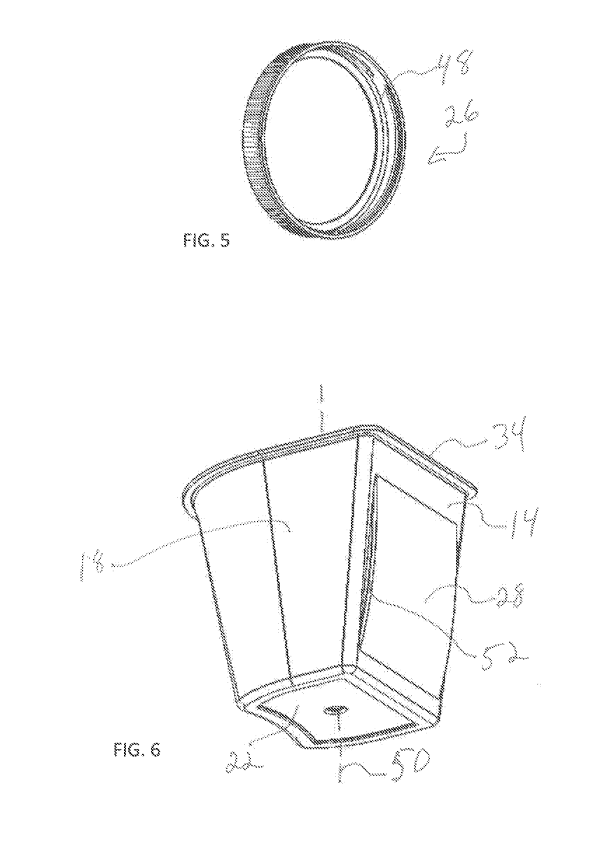

The top portion 24 comprises a neck portion 40, which can be threaded, with a circular opening 42 for receiving a specimen and a lower opening 44 defined by a peripheral portion 46 sized to the upper peripheral portion 34 of the container portion 12. The cap 26, which can be threaded 48, as shown in FIG. 5, is sized and configured to matingly couple with the neck portion 40 of the top portion.

Referring to FIGS. 6-7, the forward facing wall 14 of container 12 can be generally planer and can be inwardly angled relative to a vertical axis 50 of the container 12 downward from the upper peripheral portion 34 to the bottom wall 22. The forward facing wall 14 can further comprise a transparent viewing panel 28 incorporated for viewing the assay strip panel 30. The transparent viewing panel 28 can have a varied thickness 52 such that it curves outward from the forward facing wall 14 providing a magnification for reading test strips.

As shown, the right 16 and left 18 side walls of container 12 can be have a slight radial curvature relative to the vertical axis 50. The side walls 16, 18, can also be inwardly angled relative to a vertical axis 50 of the container 12 downward from the upper peripheral portion 34 to the bottom wall 22.

The rearward facing wall 20 of container 12 can be inwardly angled relative to a vertical axis 50 of the container 12 downward from the upper peripheral portion 34 to the bottom wall 22. The rearward facing wall 20 can comprise or define a vertically oriented recess 54. The recess 54 can be elongated and have a width 56 that narrows from the upper peripheral portion 34 to the bottom wall 22.

The bottom wall 22 of the container can define a recessed portion 58 defined by a bottom wall periphery 60. The container 12 can be tapered from the upper peripheral portion 34 to the bottom wall 22, such that the bottom wall spans a smaller area than the open top 38.

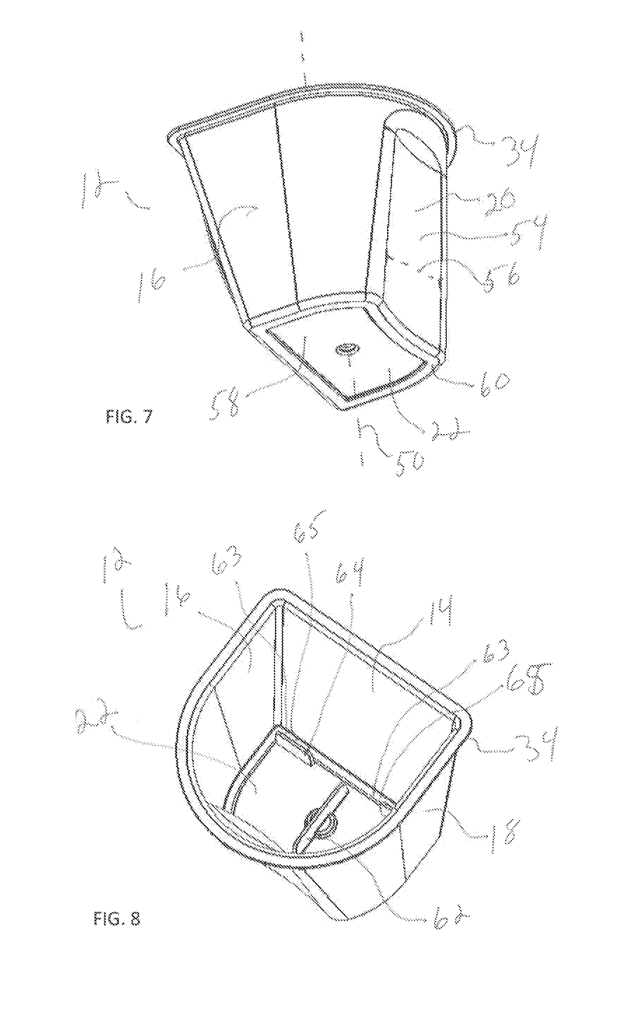

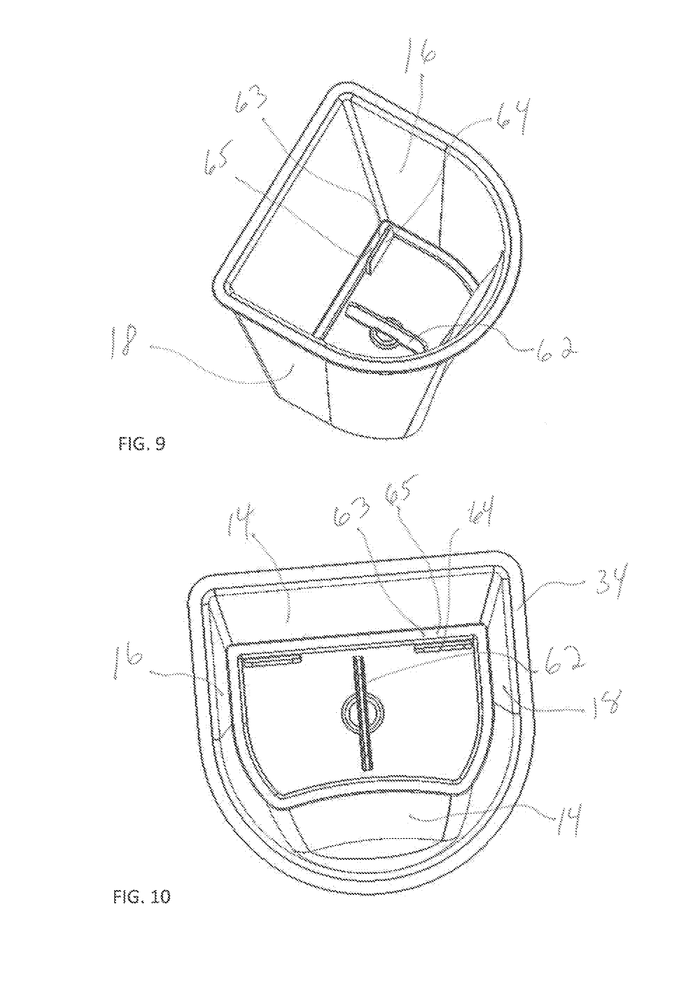

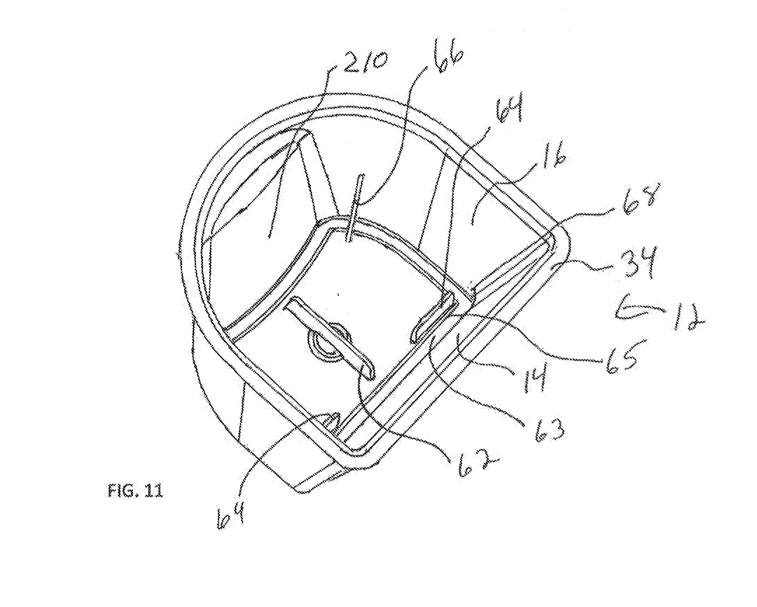

In an embodiment, FIGS. 8-10 show the open interior 32 of the container 12. The container 12 can comprise vertically oriented tab 62 extending upward from the bottom wall 22. The enter tab 62 can be elongated, running in the direction from the rearward facing wall 20 to the forward facing wall 14. The tab 62 can be centrally positioned on the bottom wall 22 and can extend a distance that is less than the distance along the bottom wall 22 from the frontward facing wall 14 to the rearward facing wall 20. The tab 62 can comprise two or more spaced tabs position along the same path on the bottom wall 22. In some embodiments, the tab 62 can be formed at any angle around the axis 50.

The container 12 can further a receiving region 63 for receiving and positioning the assay strip panel 30. The receiving region 63 can extend between the side walls 16, 18, adjacent to the forward facing wall 14. The receiving region can be configured as one or more slots 65. The one or more slots 65 can be defined by one or more aligning tabs 64. The aligning tabs 64 can be vertically oriented facing the rearward facing wall 20, extending upward from the bottom wall 22. The containing tabs 64 are positioned adjacent to the forward facing wall 14, defining slots 65 between the containing tabs 64 and the forward facing wall 14. The slots 65 are sized to receive and guide the inserted assay strip panel 30. When the assay strip panel 30 is inserted into the container 12, the containing tabs 64 hold the bottom of the assay strip panel 30 against the frontward facing wall 14. The container 12 can comprise one tab 64 defining a slot 65 or multiple containing tabs 64 spaced between the side walls 16, 18. The containing tabs 64 can be elongated, running in the direction from the right facing wall 16 to the left facing wall 18. The containing tab(s) 64 can be positioned at various positions between on the right facing wall 16 to the left facing wall 18. The containing tab(s) 64 can extend a distance that is up to or less than the distance along the bottom wall 22 from the left facing wall 18 to the right facing wall 16.

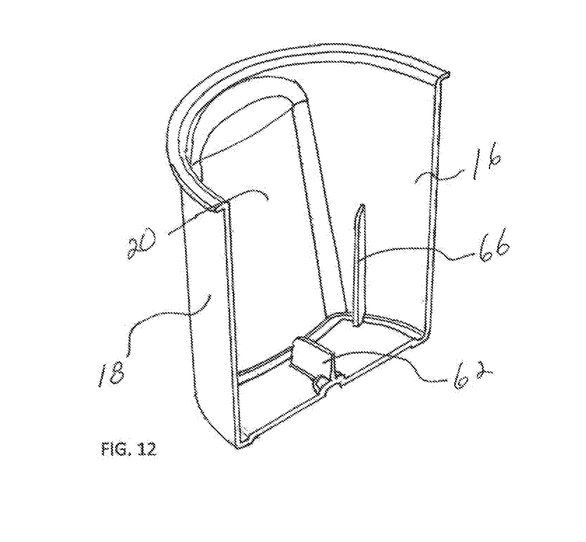

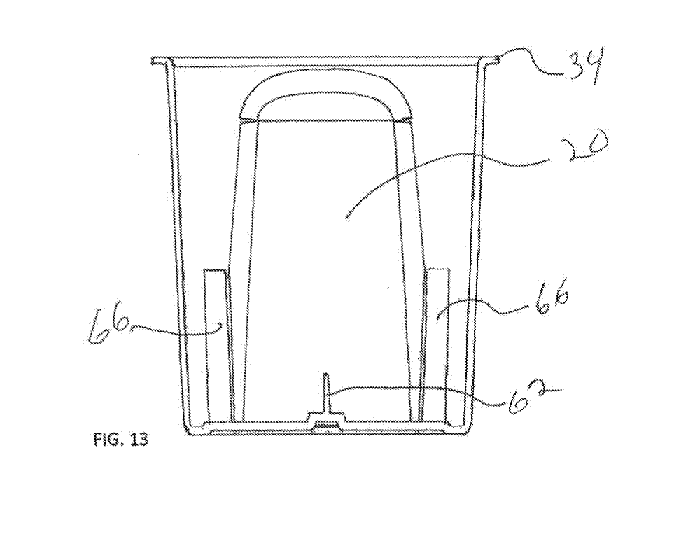

As shown in FIGS. 11-13, in some embodiments, the container 12 can comprise stacking tabs 66 positioned on the inside of the container 12. The stacking tabs 66 can be vertically oriented on the side walls 16, 18. The stacking tabs can be elongated and extend inwardly in the container 12. The stacking tabs 66 are sized to limit how far one container without a top portion can be inserted in another container. The protrusions 66 prevent the containers from getting stuck, thereby facilitating orderly stacking of multiple containers 12. The container 12 can also comprise guide tabs 68. The guide tabs 68 can be position on the side walls 16, 18, adjacent or at the bottom wall 22. The guide tabs are aligned with the slot(s) 65 so as to guide and position the inserted assay strip panel 30 to limit side to side movement of the assay strip panel 30.

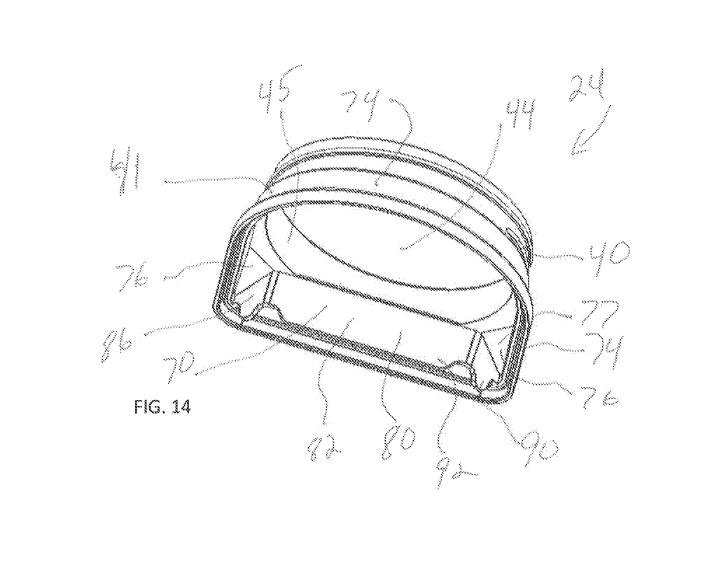

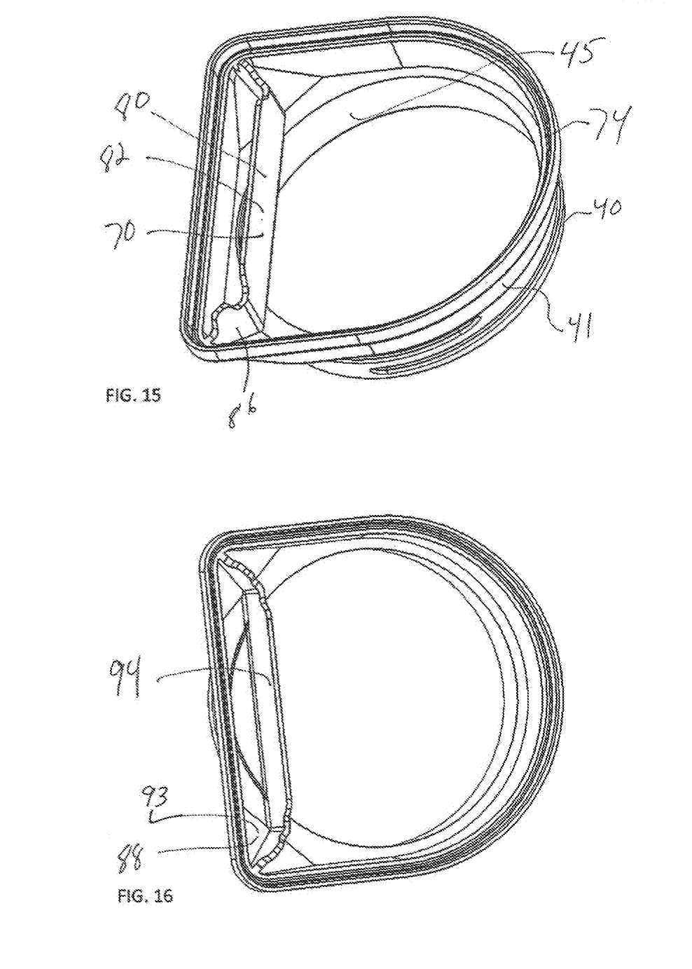

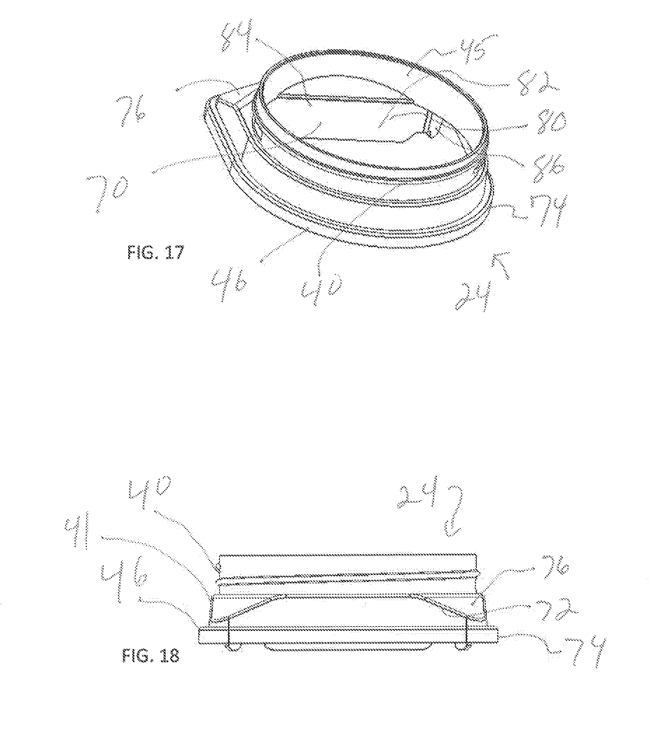

Referring to FIGS. 14-18, the top portion 24 comprises a lower portion 41 defining the periphery portion 46, the neck portion 40, a forward facing portion 72 and a rearward facing portion 74. When the top portion 24 is assembled with the container, the forward facing portion 72 is in alignment with the forward facing wall 14 of the container 12 and the rearward facing portion is aligned with the rearward facing wall of the container 12. The forward facing portion 72 of the top portion 24 can comprise downward angled shoulder portions 76 which have angled inner surfaces 77. In assembly, lower portion 41 of the top portion 24 can be secured to the periphery portion 34 of the container 12, such that the periphery 46 of the top portion 24 fits over the periphery portion 34 of the container and the lower portion 41 is sealed onto the upper lip 36 of the container 12.

The top portion 24 comprises a spanning portion 70 that, when the top portion 24 is assembled with the container portion 12, traverses the open interior 32 of the container 12 and covers the top edge portion 100 of an inserted assay strip panel 30 so as to shield the assay strip panel 30 from incoming fluid. The spanning portion 70 is positioned inside the lower portion 41 at the forward facing portion 72. The spanning portion is also a retainer, retaining the assay strip panel 30 in its slot and securing it against the frontward facing wall 14.

In some embodiments, the spanning portion 70 comprises engaging portions 80 that engage the assay strip panel 30 and secure the assay strip panel 30 against the forward facing wall 14 of the container 14. The engaging portions 80 can comprise a lateral portion 82 having a surface 83 that is forward facing, a top portion 84 that can comprise a downwardly angled portion 84 that is formed to the inner side of the neck portion 40 and extends to the lateral portion 82, and end portions 86 bookending the lateral portion 82. The end portions 82 can extend downward from the inner surface 77 of the corresponding angled shoulder portions 76. The end portions can comprise downwardly extending tabs 90 and the lateral portion 82 can form a downwardly extending tab 92.

The engaging portions 80 are configured to form an assay strip panel 30 receiving region 93 for receiving the assay strip panel 30. The receiving region 93 can be configured as a slot 94. The engaging portions 80 are configured and form such that the receiving region 93 is only downwardly exposed.

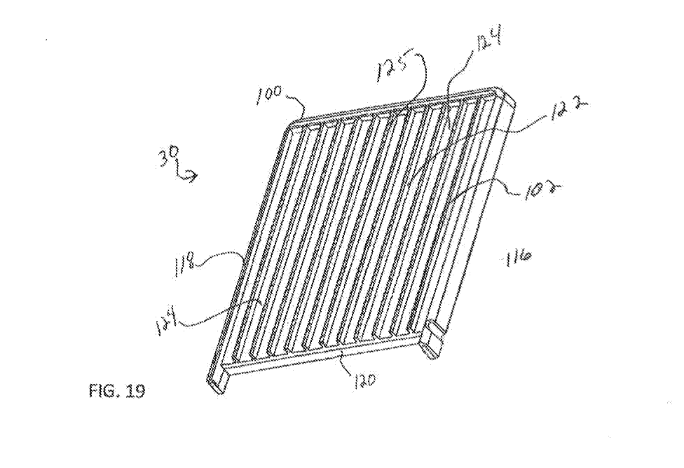

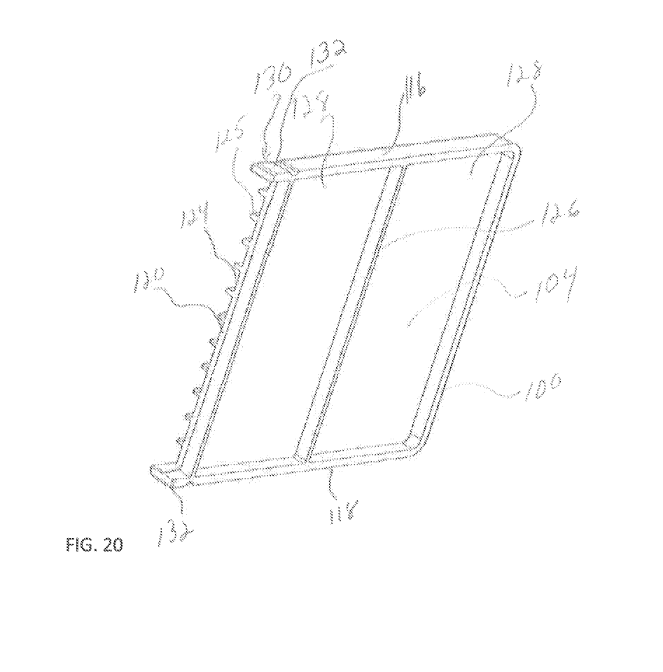

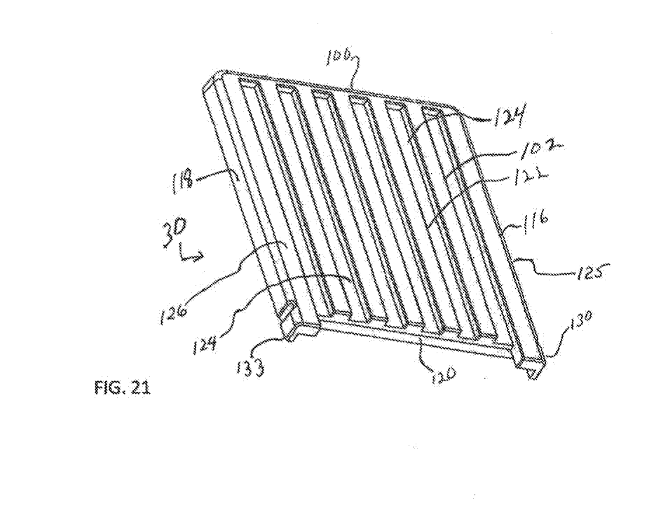

Referring to FIGS. 19-20, the assay strip panel 30 comprises a forward facing surface 102, a rearward facing surface 104, a top edge portion 100, a right side edge portion 116, a left side edge portion and bottom edge portion 120. The forward facing surface comprises an assay strip receiving region 122 for receiving assay test strips. The assay strip receiving region 122 can be configured to comprise a plurality of vertical slots 124 defined by vertical ribs 125 shaped to receive assay strips. The rearward facing surface 104 can be configured to comprise a lateral rib 126 separating one or more recesses 128. The assay strip panel 30 can further comprise spacer portions 130, which may be configured as feet 132 that extend downward from the left and right side edges 116, 118. When the assay strip panel 30 is inserted in the receiving region 63 of the container, the spacer portions 130, or feet 132, engage the bottom wall 22, keeping a space between the bottom edge portion 120 and the bottom wall 22.

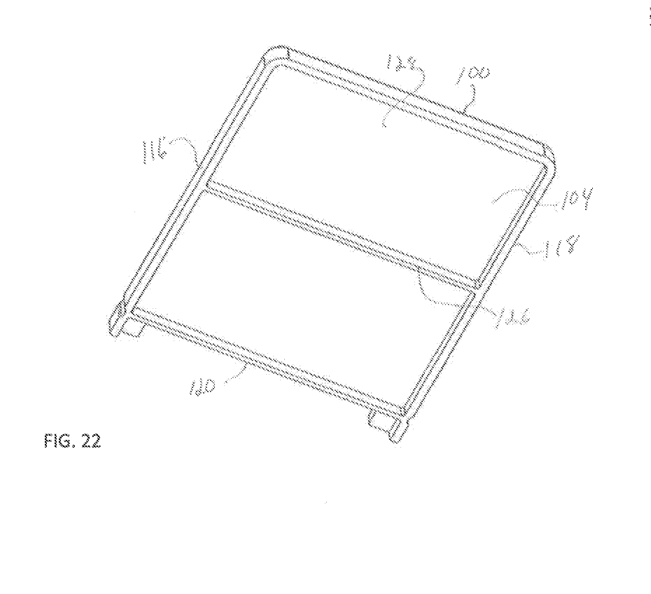

Referring to FIGS. 21-22, the assay strip receiving region 122 for receiving assay test strips can be configured to receive fewer strips, but increasing the width of the vertical ribs 125, thereby reducing the number of vertical slots 124. In the embodiment shown, the spacer portions 130, can be configured as “L” shaped feet 133 that extend downward from the left and right side edges 116, 118, and from an adjacent vertical rib 125.

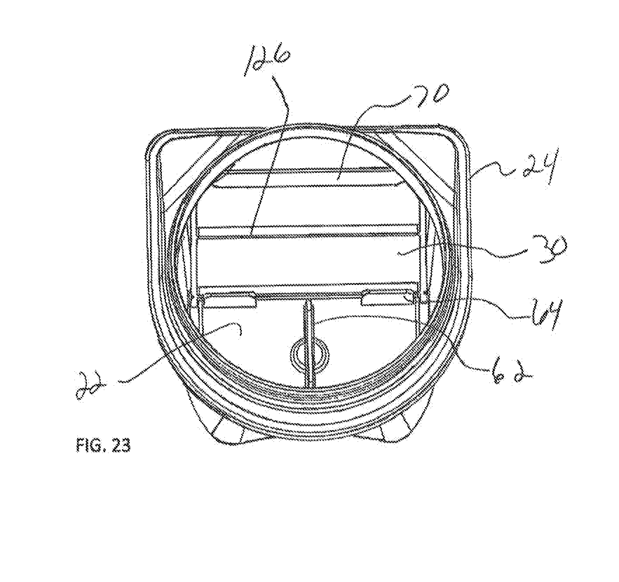

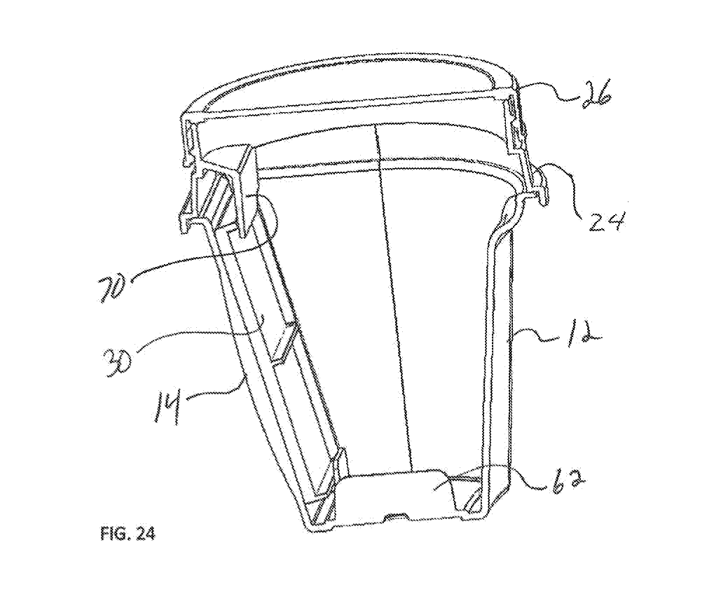

FIG. 23 show an embodiment of the specimen receiving device 10 without the cap 26, wherein the assay strip panel 30 is inserted in the receiving region 63 of the container 12 and the receiving region 93 of the top portion 24 and positioned against the frontward facing wall 14 of the container 12.

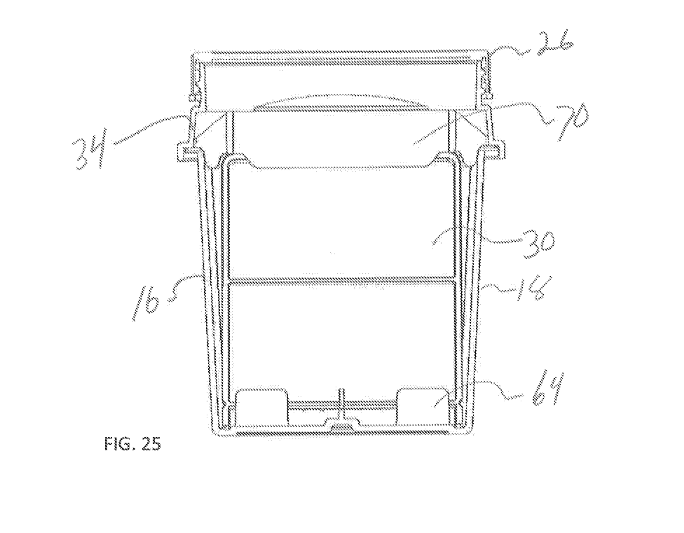

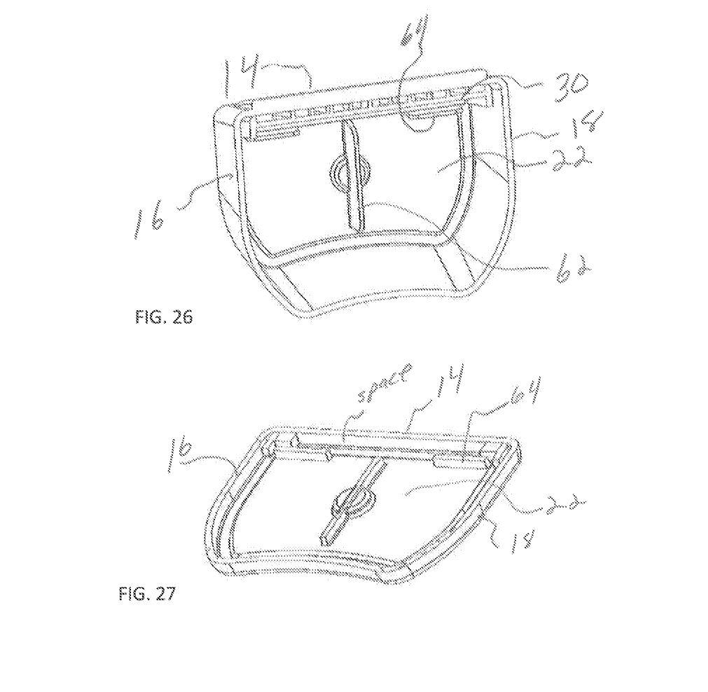

FIGS. 24-27 show various partial cut-away portions of the specimen receiving device 10 illustrating the insertion of the assay strip panel 30 in the receiving region 63 of the container 12 and the receiving region 93 of the top portion 24 and positioned against the frontward facing wall 14 of the container 12.

The specimen receiving device 10 is a fully integrated and self-contained. The integrated design eliminates handling of the urine. The device can be sealed and leak proof.

The following patents or publications are related to the technologies of the instant invention and particular teachings or features of same may be utilized in association with the various aspects disclosed herein, these patents are incorporated by reference herein:
U.S. 2007/0065339 A1; U.S. Pat. No. 6,805,838; U.S. Pat. No. 5,976,895; U.S. 2012/0094303

The above references in all sections of this application are herein incorporated by references in their entirety for all purposes. For purposes of interpreting the claims for the present invention, it is expressly intended that the provisions of Section 112, sixth paragraph of 35 U.S.C.

are not to be invoked unless the specific terms “means for” or “step for” are recited in a claim

All of the features disclosed in this specification (including the references incorporated by reference, including any accompanying claims, abstract and drawings), and/or all of the steps of any method or process so disclosed, may be combined in any combination, except combinations where at least some of such features and/or steps are mutually exclusive.

Each feature disclosed in this specification (including references incorporated by reference, any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any incorporated by reference references, any accompanying claims, abstract and drawings), or to any novel one, or any novel combination, of the steps of any method or process so disclosed The above references in all sections of this application are herein incorporated by references in their entirety for all purposes.

Although specific examples have been illustrated and described herein, it will be appreciated by those of ordinary skill in the art that any arrangement calculated to achieve the same purpose could be substituted for the specific examples shown. This application is intended to cover adaptations or variations of the present subject matter. Therefore, it is intended that the invention be defined by the attached claims and their legal equivalents, as well as the following illustrative aspects. The above described aspects embodiments of the invention are merely descriptive of its principles and are not to be considered limiting. Further modifications of the invention herein disclosed will occur to those skilled in the respective arts and all such modifications are deemed to be within the scope of the invention.

1. A specimen receiving device comprising:
a container portion having a bottom wall, a forward facing wall, a rearward facing wall, two side walls, defining an open interior and an upper peripheral portion defining an open top, the container having a slot defined at an inside wall surface of the forward facing surface;
an assay strip panel sized to be received in the slot at the inside wall surface, the assay strip panel having a forward facing surface with a plurality of vertical slots, a top edge portion and a bottom portion that seats on the bottom wall; and
a top portion sized for closing the open top and connecting with the upper lip, the top portion having a threaded neck portion with a circular opening for receiving a specimen and a lower opening defined by a peripheral portion sized to the upper peripheral portion; wherein the top portion has a spanning portion that, when the top portion is assembled with the container portion, traverses the open interior of the container portion and covers the top edge portion of the assay strip panel.

2. The specimen receiving device of claim 1 wherein the spanning portion has assay strip panel engaging portions that secure the assay strip panel against the forward facing wall of the container portion.

3. The specimen receiving device of claim 1 wherein the assay strip panel has a pair of feet extending downward for engaging the bottom wall.

4. The specimen receiving device of claim 2 wherein the assay strip panel is elevated off of the bottom wall by the feet and the assay panel comprises a plurality of test strips with each test strip having and end tip extending toward the bottom wall.

5. The specimen receiving device of claim 2 wherein the assay strip panel is elevated off of a bottom wall surface and the assay panel comprises a plurality of test strips with each test strip having and end tip extending toward the bottom wall and below a lower panel edge portion.

6. The specimen receiving device of claim 1 wherein the container portion has a recess on the rearward facing wall and the rearward facing wall and the two side walls provide a tapering towards the bottom wall.

7. A specimen receiving device comprising:
a container portion having a bottom wall, a forward facing wall, a rearward facing wall, two side walls, defining an open interior and an upper peripheral portion defining an open top, the container having a slot defined at an inside wall surface of the forward facing surface;
an assay strip panel received in the slot at the inside wall surface, the assay strip panel having a forward facing surface with a plurality of vertical slots, a top edge portion and a bottom portion that is seated at the bottom wall;
a top portion connected to the upper lip, the top portion having a threaded neck portion with a circular opening for receiving a specimen and a lower opening defined by a peripheral portion sized to the upper peripheral portion;
a shield positioned over the top edge portion of the assay strip panel and positioned below the circular opening for preventing the specimen from contacting the upper edge portion of the assay strip panel; and
a cap for cooperating with the threaded neck portion to seal and close the specimen receiving device.

8. The specimen receiving device of claim 7 where in the shield is unitary with the top portion by way of molding.

9. The specimen receiving device of claim 7 wherein the top portion is unitary with the container portion by way of welding.

10. A method of assembling a specimen receiving device comprising:
inserting a panel of test strips adjacent a forward facing wall of a container portion, the forward facing wall being transparent or having a transparent window; and
welding a top portion to the container portion, the top portion having a retainer that thereby captures and retains the panel against the forward facing wall and provides a shield over the panel to deflect collected specimen.

11. The method of claim 10 further comprising manufacturing the specimen receiving device comprising:
injection molding a generally rectangular assay test strip panel that has a top edge and a bottom edge;
injection molding a container portion having a bottom wall with a foot print of a first area, and an open top defined by a peripheral lip, the open top with an area larger than the first area whereby the container portion tapers towards the bottom wall, the container portion having a slot for receiving the assay test strip panel; and
injection molding a top portion that has a shield configured to cover the top edge of the panel.

12. (canceled)
